(19) United States
(12) Patent Application Publication
(10) Pub. No.: US 2024/0276335 A1
(43) Pub. Date: Aug. 15, 2024

(54) CELL RESELECTION EVALUATION BASED ON A LOW-RECEPTION-POWER SIGNAL

(71) Applicant: Samsung Electronics Co., Ltd., Suwon-si (KR)

(72) Inventors: Shiyang Leng, Allen, TX (US); Kyeongin Jeong, Allen, TX (US); Hongbo Si, Allen, TX (US)

(21) Appl. No.: 18/424,519

(22) Filed: Jan. 26, 2024

Related U.S. Application Data
(60) Provisional application No. 63/444,474, filed on Feb. 9, 2023.

(51) Int. Cl. H04W 36/30; H04W 36/36

(52) U.S. Cl. CPC H04W 36/30; H04W 36/362

(57) ABSTRACT

Methods and apparatuses for a cell reselection evaluation based on a low-reception-power signal in a wireless communication system. A method of a UE comprises: receiving first configuration information including an identification (ID) of at least one cell capable of using low-power (LP) signals and second configuration information including a set of threshold parameters for a cell reselection operation using the LP signals; performing, based on the first configuration information, a measurement operation on the LP signals; and performing, based on the set of threshold parameters and a measurement result of the measurement operation, the cell reselection operation.

### CROSS-REFERENCE TO RELATED APPLICATIONS AND CLAIM OF PRIORITY

The present application claims priority to U.S. Provisional Patent Application No. 63/444,474, filed on Feb. 9, 2023. The contents of the above-identified patent documents are incorporated herein by reference.

### TECHNICAL FIELD

The present disclosure relates generally to wireless communication systems and, more specifically, the present disclosure relates to a cell reselection evaluation based on a low-reception-power signal in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a cell reselection evaluation based on a low-reception-power signal in a wireless communication system.

In one embodiment, a user equipment (UE) in a wireless communication system is provided. The UE comprises a transceiver configured to receive first configuration information including an identification (ID) of at least one cell capable of using low-power (LP) signals and second configuration information including a set of threshold parameters for a cell reselection operation using LP signals. The UE further comprises a processor operably coupled to the transceiver, the processor configured to: perform, based on the first configuration information, a measurement operation on the LP signals, and perform, based on the set of threshold parameters and a measurement result of the measurement operation, the cell reselection operation.

In another embodiment, a method of a UE in a wireless communication system is provided. The method comprises: receiving first configuration information including an ID of at least one cell capable of using LP signals and second configuration information including a set of threshold parameters for a cell reselection operation using the LP signals; performing, based on the first configuration information, a measurement operation on the LP signals; and performing, based on the set of threshold parameters and a measurement result of the measurement operation, the cell reselection operation.

In yet another embodiment, a base station (BS) in a wireless communication system is provided. The BS comprises a processor configured to generate first configuration information including an ID of at least one cell capable of using LP signals and second configuration information including a set of threshold parameters for a cell reselection operation using the LP signals. The BS further comprises a transceiver operably coupled to the processor, the transceiver configured to transmit, to a UE, the first configuration information and the second configuration information, wherein: a measurement operation on the LP signals is performed based on the first configuration information, and the cell reselection operation is performed based on the set of threshold parameters and a measurement result of the measurement operation.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6 illustrates a flowchart of a UE method for a cell reselection based on LP WUS according to embodiments of the present disclosure;

FIG. 7 illustrates a flowchart of a UE method for a cell reselection based on LP WUS and SSBs according to embodiments of the present disclosure; and

FIG. 8 illustrates a flowchart of a UE method for a cell reselection evaluation based on a low-reception-power signal according to embodiments of the present disclosure.

### DETAILED DESCRIPTION

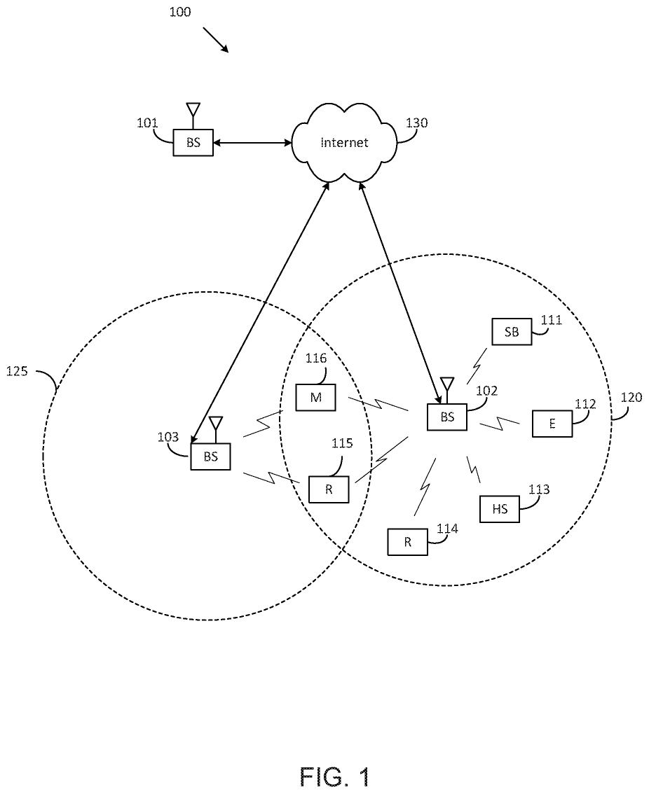

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents are hereby incorporated by reference into the present disclosure as if fully set forth herein: “3GPP, TS 38.300 v17.3.0, 5G; NR; NR and NG-RAN Overall Description; Stage 2”; “3GPP, TS 38.331 v17.3.0, 5G; NR; Radio Resource Control (RRC); Protocol specification”; and “3GPP, TS 38.304 v17.3.0, NR; User Equipment (UE) procedures in Idle mode and RRC Inactive state.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for supporting a cell reselection evaluation based on a low-reception-power signal in a wireless communication system. In certain embodiments, and one or more of the gNBs 101-103 includes circuitry, programing, or a combination thereof, for supporting a cell reselection evaluation based on a low-reception-power signal in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

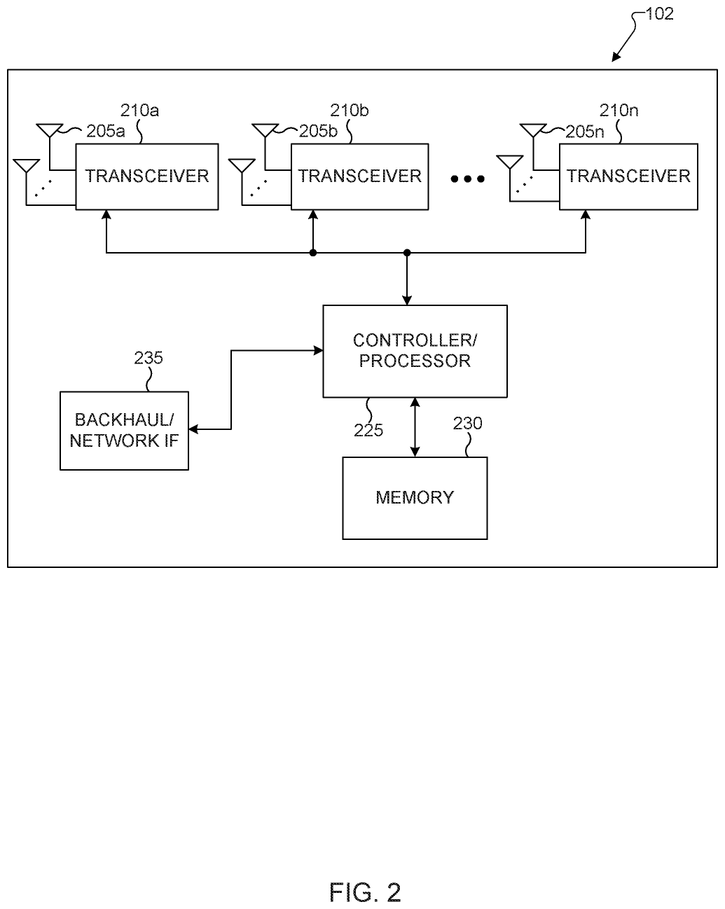

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process. The controller/processor 225 is also capable of executing programs and other processes resident in the memory 230, such as processes for supporting a cell reselection evaluation based on a low-reception-power signal in a wireless communication system.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

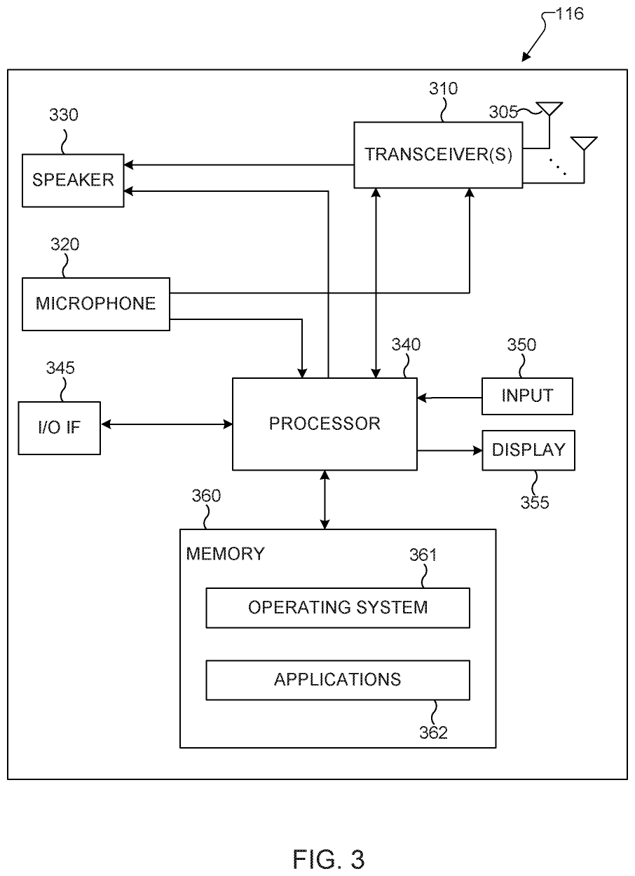

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for a cell reselection evaluation based on a low-reception-power signal in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

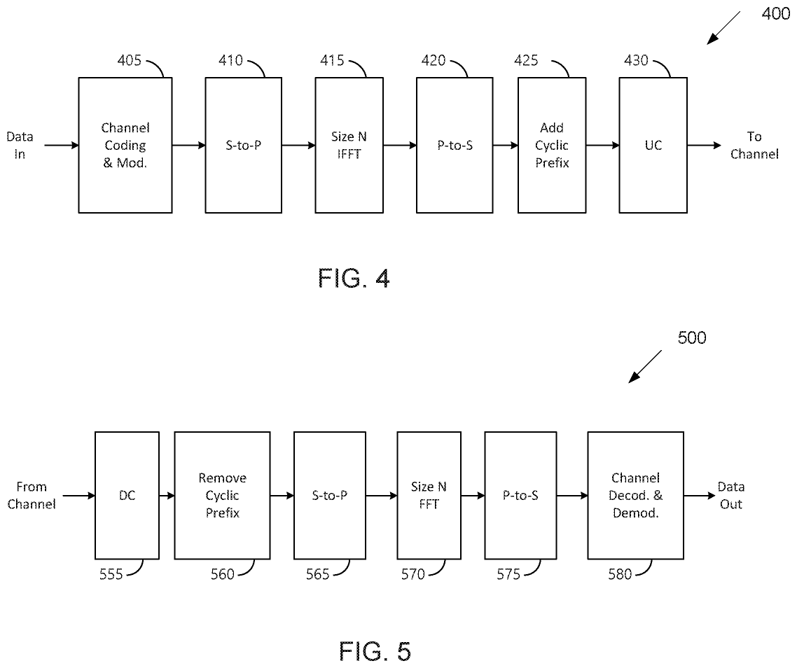

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support a cell reselection evaluation based on a low-reception-power signal in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

The 3GPP has developed technical specifications and standards to define the new 5G radio-access technology, known as 5G new radio (NR). UE energy efficiency is critical to 5G system design, especially for small form-factor devices without continuous energy source, e.g., IoT devices, industrial sensors, controllers, and wearables. To save UE power consumption, extended discontinuous reception (eDRX) with long wake-up periods is expected to be used. However, large eDRX cycles cannot meet the low latency requirement for latency-critical use cases. On the other hand, the UE needs to periodically wake up per eDRX cycle even there is no signaling or data traffic, which may waste power. It is desired that the UE can wake up with short delay, while only at triggered occasions. To this end, a wake-up signal (WUS) to trigger the main radio (MR) is to be designed and a separate receiver, namely, lower power radio (LR), which has the ability to monitor wake-up signal with ultra-low power consumption is expected to be used. Main radio works for data transmission and reception, which can be turned off or set to deep sleep unless the main radio is turned on.

In an RRC_IDLE/INACTIVE state, a UE can monitor a type of signal with low reception power (e.g., lower-power wake-up signal (LP WUS)) to reduce power consumption. To enable UE-controlled mobility in the RRC_IDLE/INACTIVE state, the UE needs to perform neighbor cell measurements and cell (re-)selection based on a low-reception-power signal, instead of SSB as in legacy operation. Thus, the criteria for cell reselection evaluation based on the low-reception-power signal needs to be designed.

In the present disclosure, the procedure and the criteria for cell reselection evaluation based on measurements of a type of low-reception-power signal are specified. Embodiments covers inter-frequency, and/or inter-frequency and/or inter-RAT cell reselection evaluation. In one instance, the terminology LP WUS can refer to a type of signal received by low power receiver with low power and can be replaced by equivalent terminology such as low power synchronization signal (LP SS). In one example, a UE in RRC_CONNECTED state monitors LP WUS.

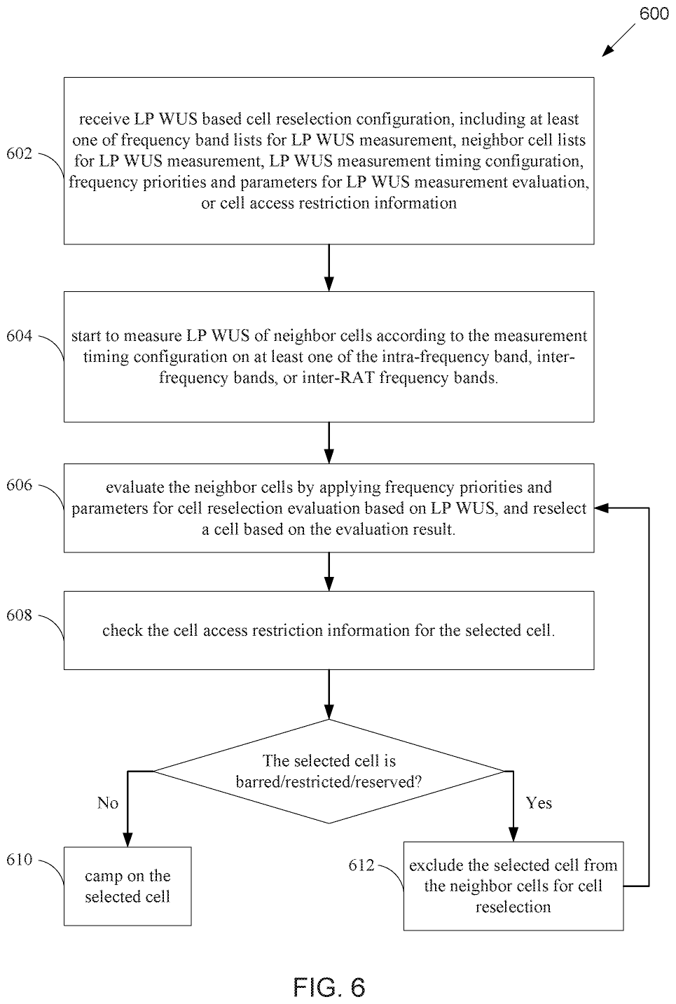

For a UE operation with lower power consumption in an RRC_IDLE/INACTIVE state, a UE can perform a cell reselection based on LP WUS. The UE can perform neighbor cell measurement of LP WUS while monitoring the serving cell's LP WUS. One embodiment of LP WUS based cell reselection procedure is illustrated in FIG. 6.

FIG. 6 illustrates a flowchart of a UE method 600 for a cell reselection based on LP WUS according to embodiments of the present disclosure. The method 600 as may be performed by a UE (e.g., 111-116 as illustrated in FIG. 1). An embodiment of the method 600 shown in FIG. 6 is for illustration only. One or more of the components illustrated in FIG. 6 can be implemented in specialized circuitry configured to perform the noted functions or one or more of the components can be implemented by one or more processors executing instructions to perform the noted functions.

As illustrated in FIG. 6, at step 602, the UE receives LP WUS based cell reselection configuration. The configuration can include at least one of frequency band lists for LP WUS measurement, neighbor cell lists for LP WUS measurement, LP WUS measurement timing configuration, frequency priorities and parameters for LP WUS measurement evaluation, or cell access restriction information. The configuration or part of the configuration can be provided in system information, and/or in the RRCRelease message, and/or by inheriting from another RAT.

At step 604, the UE starts to measure LP WUS of neighbor cells according to the measurement timing configuration on at least one of the intra-frequency band (i.e., the serving cell frequency), inter-frequency bands, or inter-RAT frequency bands. The UE can start to measure neighbor cells when the current serving cell is not in good radio condition.

At step 606, the UE evaluates the neighbor cells by applying the frequency priorities and the parameters for cell reselection evaluation based on LP WUS, and reselects a cell based on the evaluation result. At step 608, the UE checks the cell access restriction information for the selected cell. At step 610, the UE camps on the selected cell if not restricted/barred/reserved. If the selected cell is restricted/barred/reserved, the UE excludes the cell, and considers other neighbor cells in cell reselection evaluation at step 606.

For step 602, in one embodiment, the some of the LP WUS based cell reselection configuration can be provided per frequency band, while some can be provided commonly for a list of frequency bands. For one frequency band, either the intra-frequency band (i.e., the frequency band of the serving cell) or an inter-(RAT) frequency band, the configuration can include one or multiple of the following elements as shown in examples.

In one example, the configuration can include a carrier frequency of LP WUS from neighbor cells on this frequency band.

In one example, the configuration can include an indication of whether LP WUS is supported on an existing frequency for cell reselection.

In one example, the configuration can include a priority of the frequency band for LP WUS based cell reselection.

In one example, the configuration can include a list of frequencies for which the LP WUS based cell reselection parameters indicated for this frequency band apply.

In one example, the configuration can include a LP WUS measurement timing configuration (LMTC), indicating the timing occasions at which the UE measures one or more LP WUS quantities. The LMTC can include at least one of a duration, a periodicity, or an offset to indicate the measurement window in which to receive LP WUS, and/or the indexes of subframes and/or slots and/or impulses of LP WUS in a measurement window to measure a specific quantity, and/or a list of cell IDs (e.g., PCIs) that indicates the cells following this timing configuration.

In one example, the configuration can include a number of LP WUS impulses to be used to derive a measurement quantity, for which, as an example, a linear average of a measurement quantity is derived from the number of LP WUS impulses.

In one example, the configuration can include a threshold to be used to derive a LP WUS measurement quantity, for which, as an example, only the LP WUS impulse above the threshold is used to derive a measurement quantity.

In one example, the configuration can include a list of thresholds, offsets for LP WUS based cell reselection evaluation on this frequency.

In one example, the configuration can include a list of cell IDs (e.g., PCIs) that indicates the neighbor cells providing LP WUS on this frequency band.

In one example, the configuration can include a list of cell IDs (e.g., PCIs) that indicates the neighbor cells on this frequency band allowing camping through LP WUS based cell reselection.

In one example, the configuration can include a list of cell IDs (e.g., PCIs) that indicates the neighbor cells on this frequency band to be excluded for LP WUS based cell reselection.

In one example, the configuration can include a list of neighbor cells, where each entry of the list includes a cell ID (e.g., PCIs) and cell-specific information elements, where the elements can include one or more of the followings: (1) PLMN related information for the neighbor cell, which can include an index referring to a configured PLMN ID and the corresponding PLMN related information, a PLMN identity, one or more tracking area codes, one or more RAN area codes, a cell ID, a gNB ID, and a cell reserved state; (2) assistance information to acquire MIB and SIB1 of the neighbor cell, which can include the frequency, time, spatial resource location to acquire MIB and SIB1; and (3) cell-specific thresholds and offsets for cell reselection evaluation based on LP WUS.

For step 604, in an embodiment, the UE can measure LP WUS of intra-frequency, and/or inter-frequency, and/or inter-RAT frequency neighbor cells. Regarding the frequencies and/or the neighbor cells to be measured, the UE can measure LP WUS of neighbor cells on an inter-(RAT) frequency band for which the carrier frequencies and/or frequency bands are indicated supporting LP WUS in the LP WUS based cell reselection configuration. If frequencies for LP WUS are not provided, the UE can scan the frequencies for cell reselection based on existing reference signals (e.g., SSB). If the list of cell IDs for neighbor cells providing LP WUS is present, the UE measures the listed neighbor cells on the corresponding frequency. If the list of cell IDs for neighbor cells allowing camping through LP WUS based cell reselection is present, the UE measures the listed neighbor cells on the corresponding frequency. If the list of cell IDs for neighbor cells to be excluded for LP WUS based cell reselection is present, the UE ignores the listed neighbor cells on the corresponding frequency for cell reselection measurement. If none of LP-WUS-specific cell lists is present, the UE can follow the existing cell lists configured for cell reselection based on existing reference signals (e.g., SSB). If cell-specific information for a list of neighbor cells is present, the UE can measure the indicated neighbor cells on the corresponding frequency.

In another embodiment for step 604, regarding the measurement timing of neighbor cells, one or multiple LP WUS measurement timing configurations can be provided for neighbor cells on a frequency. If the LP WUS measurement timing configuration (LMTC) for a frequency is absent, the UE can follow the existing SSB measurement timing configuration (SMTC) configured for the same frequency to receive and measure LP WUS of neighbor cells. If the LP WUS measurement timing configuration for a frequency is present, the UE setups the LP WUS measurement timing configuration in accordance with the received parameters, including periodicity, and/or offset, and/or duration. If a cell list is included in the LMTC, for the cells indicated in the list, the UE applies the LTMC to receive and measure LP WUS. If any of periodicity, offset, and duration is not present in LMTC, the UE uses the corresponding parameter indicated in the SMTC configured for the same frequency/cell. For instance, LMTC includes only an offset parameter for a certain frequency/cell, then the UE can follow the periodicity and the duration in the SMTC configured for the same frequency/cell. In one example, the LMTC parameters (e.g., periodicity, and/or offset, and/or duration) can be indicated in subframes and/or in slots explicitly.

Alternatively, the LMTC parameters (e.g., periodicity, and/or offset, and/or duration) can be indicated based on the SMTC parameters for the same frequency/cell. For example, the periodicity/offset/duration in LMTC can be an integer multiple or a fraction of the periodicity/offset/duration in SMTC for the same frequency/cell, where a scalar is used to indicate the integer multiple or the fraction. The UE can identify the LP WUS measurement window by the SFN and/or the subframe derived as follows. SFN mod T=(FLOOR (offset/10)), where T=CEIL(periodicity/10); if the periodicity is larger than sf5, subframe=offset mod 10; else, subframe=offset or (offset+5), where the periodicity and offset are indicated in subframes.

In one more embodiment for step 604, for the measurement quantities, one or more measurement quantities defined for LP WUS (e.g., RSRP, RSRQ, RSSI, SINR, RSARP) can be measured by the UE. The UE can measure a quantity of LP WUS at specific timing within the measurement window if the measurement timing for the quantity is configured. The timing information can be provided by indications of subframes, and/or slots, and/or impulses. For example, the indexes of the subframes, and/or slots, and/or impulses in a measurement window can be indicated to measure a specific quantity.

In yet another embodiment for step 604, to consolidate the measurement result, if the number of LP WUS impulses to be used to derive a measurement quantity is indicated, the UE measures the indicated number of LP WUS impulses to derive the corresponding quantity. The UE can derive the quantity by averaging the measured number of LP WUS impulses. In another example, if one or more thresholds to be used to derive a LP WUS measurement quantity is indicated, the UE can use the LP WUS impulses above the minimum threshold to derive a quantity.

For step 606, when performing cell reselection evaluation based on LP WUS measurement, frequency priorities can be used for evaluation. In one embodiment, if the priority of a frequency for LP WUS based cell reselection is configured, the UE performs cell reselection evaluation for the frequencies whose priority is indicated and follows the indicated LP WUS based frequency priority; if the frequency priority for LP WUS based cell reselection is absent and the frequency priority for cell reselection evaluation based on existing reference signals (e.g., SSB) is present, the UE can follow the existing frequency priority. If the neither the LP WUS based priority nor the SSB-based priority for a frequency is present, the UE excludes the frequency for cell reselection evaluation.

In another embodiment for step 606, to determine the neighbor cells to be evaluated, if the list of cell IDs indicating neighbor cells providing LP WUS is present, the UE performs cell reselection evaluation for the indicated neighbor cells on the corresponding frequency. If the list of cell IDs indicating neighbor cells allowing camping through LP WUS based cell reselection is present, the UE performs cell reselection evaluation for the indicated neighbor cells on the corresponding frequency. If the list of cell IDs indicating neighbor cells to be excluded for LP WUS based cell reselection is present, the UE excludes the indicated neighbor cells on the corresponding frequency for cell reselection evaluation. If cell-specific information (e.g., parameters for cell reselection evaluation) of a list of neighbor cells is present, the UE performs cell reselection evaluation for the indicated neighbor cells on the corresponding frequency.

In one embodiment for step 606, regarding cell reselection criteria, the UE performs cell reselection evaluation following the existing intra-frequency, and/or inter-frequency, and/or inter-RAT frequency cell reselection criteria. When applying the existing criteria for LP WUS based cell reselection evaluation, in one example, the LP-WUS-specific parameters (e.g., thresholds, offsets) are used if configured; in another example, the UE derives a parameter value by altering the value of an existing parameter (e.g., thresholds and/or offsets for SSB based cell reselection) by an offset, where the offset is configured for LP-WUS based cell reselection evaluation.

In another embodiment for step 606, the UE evaluates the inter-frequency cells following the criteria specified for LP WUS based cell reselection. Given the absolute priorities of frequencies, the UE performs cell reselection evaluation and attempts to camp on a cell on the highest priority frequency available. The example for evaluation criteria of inter-(RAT) frequencies are specified as follows.

For a NR frequency or inter-RAT frequency that has a higher priority than the serving cell frequency: (1) if the relevant parameters are provided and the UE has camped on the current serving cell for more than a certain duration (e.g., 1 second), the UE performs cell reselection to a cell on the higher priority frequency if Quantity-1 of the cell satisfies ConditionHigh-1 during a cell reselection time interval, where the relevant parameters are applied in ConditionHigh-1; and (2) otherwise (i.e., the relevant parameters are absent), if the UE has camped on the current serving cell for more than a certain duration (e.g., 1 second), the UE performs cell reselection to a cell on the higher priority frequency if Quantity-2 of the cell satisfies ConditionHigh-2 during a cell reselection time interval.

In one example, Quantity-1 and Quantity-2 can be the same or different quantities, e.g., RSRP, RSRQ, RSSI, SINR, RSARP. Quantity-1 and Quantity-2 can be derived based on pre-defined rules applying the configured thresholds and offsets for inter-(RAT) frequency cell reselection evaluation based on LP WUS. For example, Quantity-1 can be Squal_{LPWUS} which is the LP WUS quality level value, and Quantity-2 can be Srxlev_{LPWUS} which is the LP WUS received level value. Squal_{LPWUS} and Srxlev_{LPWUS} can be derived as follows, respectively, as shown in TABLE 1.

TABLE 1
Squal_{LPWUS} and Srxlev_{LPWUS}

| - | Squal_{LPWUS} = Qqualmeas_{LPWUS} − (Qqualmin_{LPWUS} + Qqualminoffset_{LPWUS}) − | |
|---|---|---|
| | Qoffsettemp_{LPWUS}, where | |
| | ∘ | Qqualmeas_{LPWUS} is the measured LP WUS quality level (i.e., RSRQ of LP |
| | | WUS), |
| | ∘ | Qqualmin_{LPWUS} is the minimum required LP WUS quality level, which can be |
| | | added with a cell-specific parameter (e.g., Qqualminoffsetcell_{LPWUS}) if provided, |
| | ∘ | Qqualminoffset_{LPWUS} is an offset taken into account the frequency priority, |
| | ∘ | Qoffsettemp_{LPWUS} is an offset temporarily applied to LP WUS measurement. |
| - | Srxlev_{LPWUS} = Qrxlevmeas_{LPWUS} − (Qrxlevmin_{LPWUS} + Qrxlevminoffset_{LPWUS}) − | |
| | Qoffsettemp_{LPWUS}, where | |
| | ∘ | Qrxlevmeas_{LPWUS} is the measured LP WUS received level (i.e., RSRP of LP |
| | | WUS), |
| | ∘ | Qrxlevmin_{LPWUS} is the minimum required LP WUS received level, which can be |
| | | added with a cell-specific parameter (e.g., Qrxlevminoffsetcell_{LPWUS}) if |
| | | provided, |
| | ∘ | Qrxlevminoffset_{LPWUS} is an offset taken into account the frequency priority, |
| | ∘ | Qoffsettemp_{LPWUS} is an offset temporarily applied to LP WUS measurement. |

In one example, ConditionHigh-1 can be that Quantity-1 of a cell on a higher priority frequency is larger or smaller than a threshold, and ConditionHigh-2 can be that Quantity-2 of a cell on a higher priority frequency is larger or smaller than another threshold. For example, for Squal_{LPWUS} and Srxlev_{LPWUS}, ConditionHigh-1 and ConditionHigh-2 can be as follows, respectively, as shown in TABLE 2.

TABLE 2
Squal_{LPWUS} and Srxlev_{LPWUS}

| | |
|---|---|
| - | Squal_{LPWUS} > ThreshHighQ_{LPWUS}, where ThreshHighQ_{LPWUS} is a threshold of LP WUS |
| | quality level to be applied for reselecting a cell on a higher priority frequency; |
| - | Srxlev_{LPWUS} > ThreshHighP_{LPWUS}, where ThreshHighP_{LPWUS} is a threshold of LP WUS |
| | received level to be applied for reselecting a cell on a higher priority frequency. |

In one example, the cell reselection time interval can be LP-WUS specific; alternatively, the UE can follow the time interval for cell reselection based on existing reference signals (e.g., SSB) if LP-WUS-specific value is not provided. In another example, a duration offset can be indicated, and the UE derive the LP-WUS specific cell reselection time interval by altering the existing time interval by the indicated duration offset.

For a NR frequency or inter-RAT frequency that has a lower priority than the serving cell frequency, the UE evaluates the inter-frequency cells by applying the criteria specified for LP WUS based cell reselection as follows: (1) if the relevant parameters are provided and the UE has camped on the current serving cell for more than a certain duration (e.g., 1 second), the UE performs cell reselection to a cell on the lower priority frequency if Quantity-1 of the cell satisfies ConditionLowX-1 during a cell reselection time interval and Quantity-1 of the current serving cell satisfies ConditionLowServing-1, where the relevant parameters are applied in ConditionLowX-1 and ConditionLowServing-1; and (2) otherwise (i.e., the relevant parameters are absent), if the UE has camped on the current serving cell for more than a certain duration (e.g., 1 second), the UE performs cell reselection to a cell on the lower priority frequency if Quantity-2 of the cell satisfies ConditionLowX-2 during a cell reselection time interval and Quantity-2 of the current serving cell satisfies ConditionLowServing-2.

In one example, Quantity-1 and Quantity-2 can be the same or different quantities, e.g., RSRP, RSRQ, RSSI, SINR, RSARP. Quantity-1 and Quantity-2 can be derived based on pre-defined rules applying the configured thresholds and offsets for inter-(RAT) frequency cell reselection evaluation based on LP WUS. Examples for higher priority frequencies mentioned above that specify Squal_{LPWUS} and Srxlev_{LPWUS} for Quantity-1 and Quantity-2 can be applied. In one example, ConditionLowX-1 can be Quantity-1 of a cell on a lower priority frequency is large or smaller than a threshold, ConditionLowServing-1 can be Quantity-1 of the current serving cell is large or smaller than another threshold, and ConditionLowX-2 can be Quantity-2 of a cell on a lower priority frequency is larger or smaller than one more threshold, ConditionLowServing-2 can be Quantity-2 of the current serving cell is larger or smaller than one another threshold.

In one example, for Squal_{LPWUS} and Srxlev_{LPWUS}, the conditions can be as follows, respectively, as shown in TABLE 3.

TABLE 3
Squal_{LPWUS} and Srxlev_{LPWUS}

| | |
|---|---|
| - | ConditionLowX-1: Squal_{LPWUS} of a cell on the lower priority frequency > |
| | ThreshLowQ_{LPWUS}, where ThreshLowQ_{LPWUS} is a threshold of LP WUS quality level to |
| | be applied for reselecting a cell on a lower priority frequency; |
| - | ConditionLowX-2: Srxlev_{LPWUS} of a cell on the lower priority frequency > |
| | ThreshLowP_{LPWUS}, where ThreshLowP_{LPWUS} is threshold of LP WUS received level to |
| | be applied for reselecting a cell on a lower priority frequency. |
| - | ConditionLowServingX-1: Squal_{LPWUS} of the current serving cell < |
| | ThreshLowServingQ_{LPWUS}, where ThreshLowServingQ_{LPWUS} is a threshold of LP WUS |
| | quality level to be applied on the serving cell for reselecting a cell on a lower priority |
| | frequency; |
| - | ConditionLowServing-2: Srxlev_{LPWUS} of the current serving cell < |
| | ThreshLowServingP_{LPWUS}, where ThreshLowServingP_{LPWUS} is a threshold of LP WUS |
| | received level to be applied on the serving cell for reselecting a cell on a lower priority |
| | frequency. |

In one example, the cell reselection time interval can be LP-WUS specific; alternatively, the UE can follow the time interval configured for SSB based cell reselection, if LP WUS specific value is not provided. In another example, a duration offset can be indicated, and the UE derive the LP-WUS specific cell reselection time interval by altering the existing cell reselection time interval by the indicated duration offset.

In yet another embodiment of step 606, for intra-frequency and equal priority inter-frequency neighbor cells, or for inter-frequency bands that more than one cells meets the above criteria for the inter-frequency with higher/lower priorities, the UE performs evaluation by applying the cell-ranking criteria specified for LP WUS based cell reselection and reselects a cell.

In one example, to determine the cells to be ranked, the UE first excludes neighbor cells which does not meet the minimum requirement. The minimum requirement can be that one or more measurement quantities (e.g., RSRP, RSRQ, SINR, RSSI, RSARP) of a neighbor cell are larger than the minimum thresholds, e.g., the S criteria: Squal_{LPWUS}>0, Srxlev_{LPWUS}>0, where Squal_{LPWUS} and Srxlev_{LPWUS} are defined as aforementioned. The UE can use the cell-specific parameters (e.g., thresholds, offsets), if provided, to check the minimum requirement.

As an example of cell ranking, for the cells to be ranked, the UE derives an R value for each cell so that the cell with a larger R value has a higher rank, and the UE reselects the highest ranked cell. One way to derive the R value is as follows, as shown in TABLE 4.

TABLE 4
Cell ranking

| - | For the current serving cell, Rs = Qservmeas_{LPWUS} +Qhyst_{LPWUS} − Qoffsettemp_{LPWUS}, | |
|---|---|---|
| | where | |
| | ∘ | Qservmeas_{LPWUS} is the serving cell measurement quantity of LP WUS (e.g., |
| | | RSRP, RSRQ, SINR, RSSI, RSARP); |
| | ∘ | Qhyst_{LPWUS} is a hysteresis value for cell ranking based on LP WUS; |
| | ∘ | Qoffsettemp_{LPWUS} is an offset temporarily applied to LP WUS measurement. |
| - | For a neighbor cell, Rn = Qneighmeas_{LPWUS} −Qoffset_{LPWUS} − Qoffsettemp_{LPWUS}, where | |
| | ∘ | Qneighmeas_{LPWUS} is the neighbor cell measurement quantity of LP WUS (e.g., |
| | | RSRP, RSRQ, SINR, RSSI, RSARP); |
| | ∘ | Qoffset_{LPWUS} is an offset taking into account the neighbor cell is intra-frequency |
| | | or inter-frequency; |
| | ∘ | Qoffsettemp_{LPWUS} is an offset temporarily applied to LP WUS measurement. |

In another embodiment, if the UE measures LP WUS in multiple beams of a cell, the number of good beams for some high ranked cells can be considered. For example, the UE can reselect a cell which is ranked within a certain range to the highest rank (e.g., according to parameter RangeToBestCell_{LPWUS} if configured) and has the largest number of beams that a measurement quantity of the beams is larger than a threshold (e.g., absThreshRanking_{LPWUS}) if configured. In one example, the LP-WUS-specific parameter RangeToBestCell_{LPWUS} and/or absThreshRanking_{LPWUS} can be configured; alternatively, the existing parameters (e.g., rangeToBestCell and/or absThreshSS-BlocksConsolidation) for multi-beam SSB-based cell reselection can be used.

For step 608, the UE checks the cell access restriction information for the selected cell. In one embodiment, if the cell access restriction information is broadcast in system information and received by the UE (e.g., step 602), the UE can check accordingly. If the selected cell can be accessed according to the cell access restriction information, the UE camps on the selected cell (e.g., step 610) or the UE further checks cell-specific access information for the selected cell; otherwise, the UE excludes the selected cell and considers other neighbor cells for evaluation and reselection (e.g., step 412). In one example, if the list of cell IDs indicating neighbor cells allowing camping through LP WUS based cell reselection is present, the UE checks whether the selected cell is included in the allowed list. If not, the UE excludes the selected cell (e.g., step 612) and considers other neighbor cells in the evaluation and reselection. If yes, the UE can further check the cell-specific access information (e.g., PLMN information, cell barred/reserved information).

For another example, if the list of cell IDs indicating neighbor cells to be excluded for LP WUS based cell reselection is present, the UE checks whether the selected cell is indicated to be excluded. If yes, the UE excludes the selected cell (e.g., step 612) and considers other neighbor cells in the evaluation and reselection. If not, the UE can further the checks cell-specific access information.

In one embodiment of step 608, the cell-specific access information is broadcast in system information for LP WUS based cell reselection. If the selected cell can be accessed according to the cell-specific access information, the UE camps on the selected cell (e.g., step 610); otherwise, the UE excludes the selected cell and considers other neighbor cells for evaluation and reselection (e.g., step 612). In one example, the cell-specific access information for a cell can include an index referring to a PLMN ID and the corresponding PLMN related information provided by the current serving cell. In another example, the cell-specific access information for a cell can directly include the PLMN identity, and/or closed access group (CAG) IDs, and/or one or more tracking area codes, and/or one or more RAN area codes, and/or a cell ID, and/or a gNB ID, and/or a cell barred/reserved state.

In one example, to camp on a suitable cell, the UE checks if the selected cell meets the access conditions, which can include one or more of the followings, as shown in TABLE 5.

TABL 5
Determination the access condition

| - | The cell is part of either the selected PLMN or the registered PLMN or a PLMN of the | |
|---|---|---|
| | Equivalent PLMN list, and either | |
| | ∘ | the PLMN ID is not associated to any CAG-IDs and CAG-only indication is |
| | | absent or false; or |
| | ∘ | the PLMN ID is associated to a CAG-ID which is indicated in the allowed CAG |
| | | list for the cell. |

| | |
|---|---|
| - | The cell is not barred for a UE operating with LP WUS. |
| - | The cell is part of at least one tracking area that is not part of the list of “Forbidden |
| | Tracking Areas for Roaming” which belongs to a PLMN that fulfils the PLMN related |
| | condition above. |
| - | The cell is not reserved. |

If the selected cell can be accessed by checking the cell access restriction information and cell-specific access information, it is considered as a suitable cell and the UE camps on the cell in a normal state.

In another embodiment, if the UE is currently camping on any cell state, the UE can reselect a cell based on the cell reselection evaluation (e.g., operation 606), checks the selected the cell is not barred to the UE by using the provided cell access restriction information and/or cell-specific access information, and camps on any cell state.

When attempting to camp on the selected cell, in one embodiment of operation 610, the UE can turn on the MR and acquire the MIB and/or SIB1 of the selected cell by applying the MIB/SIB1 acquisition assistance information if provided. The MIB/SIB1 acquisition assistance information can include the radio resource location information in frequency, time, or space domain for the UE to identify MIB/SIB1. For example, the time domain location can be indicated by SFN, and/or subframe, and/or slot number; the space domain location can be indicated by beam index, and/or QCL information, and/or SSB index.

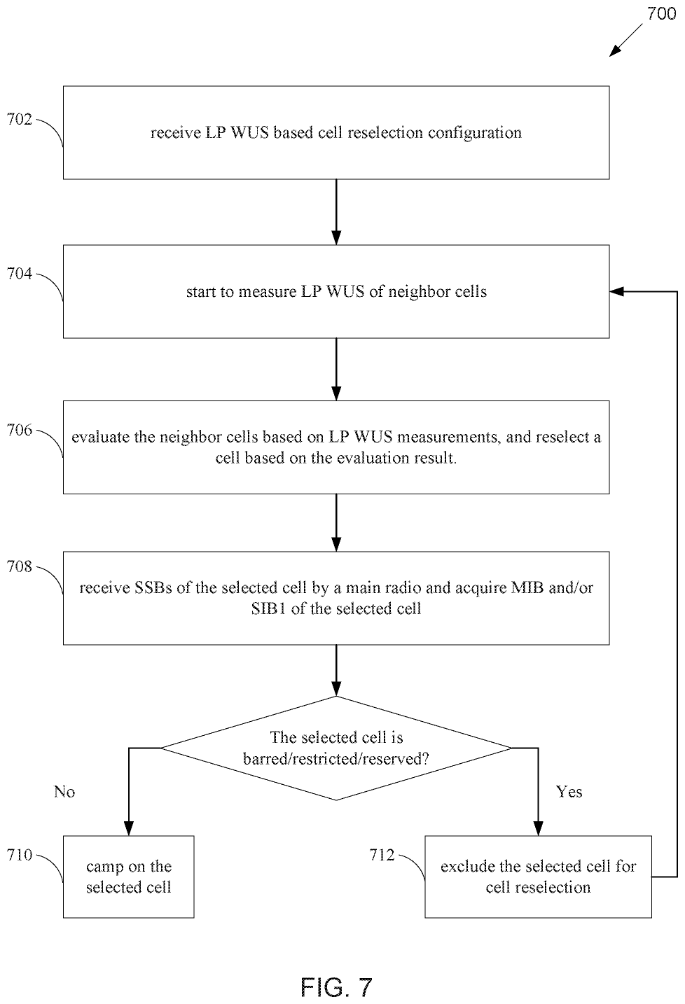

FIG. 7 illustrates a flowchart of a UE method 700 for a cell reselection based on LP WUS and SSBs according to embodiments of the present disclosure. The method 700 as may be performed by a UE (e.g., 111-116 as illustrated in FIG. 1). An embodiment of the method 700 shown in FIG. 7 is for illustration only. One or more of the components illustrated in FIG. 7 can be implemented in specialized circuitry configured to perform the noted functions or one or more of the components can be implemented by one or more processors executing instructions to perform the noted functions.

In yet another embodiment as illustrated in FIG. 7, the UE may receive the SSBs of the selected cell by the MR and acquire the MIB and/or SIB1 of the selected cell. As shown in FIG. 7, the UE first receives LP WUS based cell reselection configuration using the MR, then starts to measure LP WUS from neighbor cells for cell reselection, performs cell reselection evaluation, and reselects a cell. The embodiments aforementioned for steps 602, 604, 606, 608 can be applied to steps 702, 704, 706. At step 708, the UE receives SSBs of the selected cell by the MR and acquires MIB and/or SIB1 of the selected cell. At steps 710, 712, If the selected cell can be accessed according to the cell access information (e.g., PLMN related information, barring information) in SIB1, the UE camps on the cell; otherwise, the UE excludes the cell and continues to perform cell reselection evaluation based on LP WUS measurements, or SSB measurements, or both LP WUS and SSB measurements.

In one example, the UE searches and receives the SSBs of the selected cell by MR whenever the UE reselects a cell by LP WUS based cell reselection evaluation and attempts to camp on the selected cell. In another example, the UE searches and receives the SSBs of the selected cell with MR if the selected cell's cell access restriction information or cell-specific access information (e.g., PLMN information) or the MIB/SIB1 acquisition assistance information is absent in the current serving cell's system information. By receiving the SSBs of the selected cell and acquiring the MIB and SIB1, the UE can check the selected cell's cell access restriction information or cell-specific access information (e.g., PLMN information, barring information). In yet another example, the UE can be triggered to turn on MR by a certain cause, (e.g., system information update).

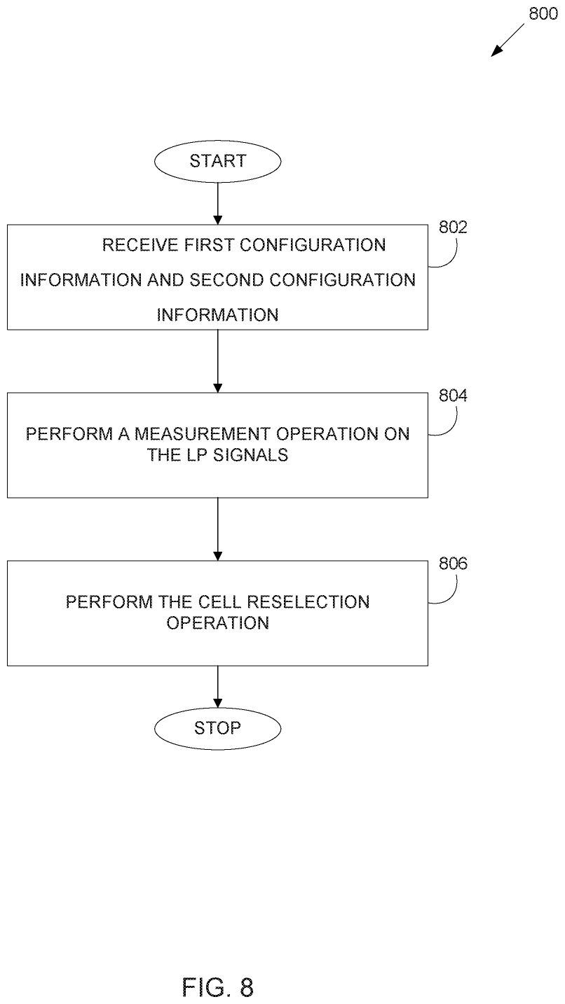

FIG. 8 illustrates a flowchart of a UE method 800 for a cell reselection evaluation based on a low-reception-power signal according to embodiments of the present disclosure. The method 800 as may be performed by a UE (e.g., 111-116 as illustrated in FIG. 1). An embodiment of the method 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

As illustrated in FIG. 8, the method 800 begins at step 802. In step 802, a UE receives first configuration information including an ID of at least one cell capable of using LP signals and second configuration information including a set of threshold parameters for a cell reselection operation using the LP signals.

In step 802, the first configuration information further includes at least one of frequency information to communicate with the LP signals and LP signal measurement timing information including at least one of a periodicity, a duration, and a timing offset.

In step 804, the second configuration information further includes at least one of a set of offset parameters for the cell reselection operation and cell access information.

In step 804, the UE performs, based on the first configuration information, a measurement operation on the LP signals.

In step 806, the UE performs, based on the set of threshold parameters and a measurement result of the measurement operation, the cell reselection operation.

In one embodiment, the UE performs the measurement operation for the LP signals over a frequency identified by the frequency information included in the first configuration information.

In one embodiment, the UE performs, based on the LP signal measurement timing information, the measurement operation for the LP signals.

In one embodiment, the UE obtains, based on the set of offset parameters, a set of parameter values of the LP signal for the cell reselection operation.

In one embodiment, the UE determines, based on the cell access information, a cell where the UE camps.

In one embodiment, the UE receives the LP signals, wherein the LP signal comprise an LP WUS or an LP SS.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive first configuration information including an identification (ID) of at least one cell capable of using low-power (LP) signals and second configuration information including a set of threshold parameters for a cell reselection operation using LP signals; and
a processor operably coupled to the transceiver, the processor configured to:
perform, based on the first configuration information, a measurement operation on the LP signals, and
perform, based on the set of threshold parameters and a measurement result of the measurement operation, the cell reselection operation.

2. The UE of claim 1, wherein the first configuration information further includes at least one of frequency information to communicate with the LP signals and LP signal measurement timing information including at least one of a periodicity, a duration, and a timing offset.

3. The UE of claim 2, wherein the processor is further configured to perform the measurement operation for the LP signals over a frequency identified by the frequency information included in the first configuration information.

4. The UE of claim 2, wherein the processor is further configured to perform, based on the LP signal measurement timing information, the measurement operation for the LP signals.

5. The UE of claim 1, wherein the second configuration information further includes at least one of a set of offset parameters for the cell reselection operation and cell access information.

6. The UE of claim 5, wherein the processor is further configured to obtain, based on the set of offset parameters, a set of parameter values of the LP signal for the cell reselection operation.

7. The UE of claim 5, wherein the processor is further configured to determine, based on the cell access information, a cell where the UE camps.

8. The UE of claim 1, further comprising a low power receiver to receive the LP signals, wherein the LP signal comprise a LP wake-up signal (LP WUS) or a LP synchronization signal (LP SS).

9. A method of a user equipment (UE) in a wireless communication system, the method comprising:
receiving first configuration information including an identification (ID) of at least one cell capable of using low-power (LP) signals and second configuration information including a set of threshold parameters for a cell reselection operation using the LP signals;
performing, based on the first configuration information, a measurement operation on the LP signals; and
performing, based on the set of threshold parameters and a measurement result of the measurement operation, the cell reselection operation.

10. The method of claim 9, wherein the first configuration information further includes at least one of frequency information to communicate with the LP signals and LP signal measurement timing information including at least one of a periodicity, a duration, and a timing offset.

11. The method of claim 10, further comprising performing the measurement operation for the LP signals over a frequency identified by the frequency information included in the first configuration information.

12. The method of claim 10, further comprising performing, based on the LP signal measurement timing information, the measurement operation for the LP signals.

13. The method of claim 10, wherein the second configuration information further includes at least one of a set of offset parameters for the cell reselection operation and cell access information.

14. The method of claim 13, further comprising obtaining, based on the set of offset parameters, a set of parameter values of the LP signal for the cell reselection operation.

15. The method of claim 13, further comprising determining, based on the cell access information, a cell where the UE camps.

16. The method of claim 9, further comprising receiving the LP signals, wherein the LP signal comprise a LP wake-up signal (LP WUS) or a LP synchronization signal (LP SS).

17. A base station (BS) in a wireless communication system, the BS comprising:
a processor configured to generate first configuration information including an identification (ID) of at least one cell capable of using low-power (LP) signals and second configuration information including a set of threshold parameters for a cell reselection operation using the LP signals; and
a transceiver operably coupled to the processor, the transceiver configured to transmit, to a user equipment (UE), the first configuration information and the second configuration information,
wherein:
a measurement operation on the LP signals is performed based on the first configuration information, and
the cell reselection operation is performed based on the set of threshold parameters and a measurement result of the measurement operation.

18. The BS of claim 17, wherein the first configuration information further includes at least one of frequency information to communicate with the LP signals and LP signal measurement timing information including at least one of a periodicity, a duration, and a timing offset.

19. The BS of claim 17, wherein the second configuration information further includes at least one of a set of offset parameters for the cell reselection operation and cell access information.

20. The BS of claim 17, wherein the LP signal comprise a LP wake-up signal (LP WUS) or a LP synchronization signal (LP SS), and the transceiver is further configured to include a low power receiver to receive the LP signals.
